(19) United States
(12) Patent Application Publication
(10) Pub. No.: US 2011/0169916 A1
(43) Pub. Date: Jul. 14, 2011

(54) METHOD OF DISPLAYING IMAGE AND DISPLAY APPARATUS FOR PERFORMING THE SAME

(75) Inventors: Kosei TANAHASHI, Cheonan-si (KR); Jun-Seok LEE, Goyang-si (KR)

(73) Assignee: SAMSUNG ELECTRONICS CO., LTD., Suwon-si (KR)

(21) Appl. No.: 12/871,316

(22) Filed: Aug. 30, 2010

(30) Foreign Application Priority Data
Jan. 11, 2010 (KR) 2010-2110

(51) Int. Cl. H04N 13/02

(52) U.S. Cl. 348/46; 348/42; 348/E13.074

(57) ABSTRACT

A method of producing and a display apparatus for a three-dimensional or two-dimensional image is presented. First unit pixel data and second unit pixel data are generated from an input image. The first unit pixel data and the second unit pixel data are provided to first and second unit pixels to display first and second images, respectively. The first unit pixel has a wavelength range corresponding to a primary color that is different from a wavelength range of the second unit pixel corresponding to the primary color. When a stereoscopic image is displayed, the first image for a left eye and the second image for a right eye may be selectively provided to the left eye and the right eye of an observer although the first and second images are displayed at the same time. Thus, an afterimage may be prevented.

### CROSS REFERENCE TO RELATED APPLICATION

This application claims priority from and the benefit of Korean Patent Application No. 2010-2110, filed on Jan. 11, 2010, which is hereby incorporated by reference for all purposes as if fully set forth herein.

### BACKGROUND OF THE INVENTION

1. Field of the Invention

Exemplary embodiments of the present invention relate to a method of displaying an image and a display apparatus for performing the method. More particularly, exemplary embodiments of the present invention relate to a method of displaying an image capable of enhancing display quality and a display apparatus for performing the method.

2. Discussion of the Background

Recently, as demand for three-dimensional (3D) images in computer games, movies, etc., has increased, a 3D image display apparatus to display a 3D image has received noticeable attention.

Generally, the 3D image display apparatus displays a first image for a left eye and a second image for a right eye having binocular disparity so that the first image and the second image are displayed to the left eye and the right eye, respectively, of an observer. The observer watches the first image with the left eye and the second image with the right eye, and the observer's brain combines the first image and the second image to perceive a 3D effect.

The 3D image display apparatus may be classified into a glass type and a non-glass type. The non-glass type display apparatus may be classified into a parallax barrier type or a lenticular type. The non-glass type display apparatus may allow the 3D image to be seen without glasses, but observation positions with respect to the display apparatus may be limited. Accordingly, the non-glass type display apparatus may be limited in that a plurality of observers may not be able to perceive a high quality 3D effect.

Alternatively, the glass type display apparatus may be classified into an anaglyph and a liquid crystal shutter glass type. With the anaglyph type, a user wears a pair of glasses having a blue lens for one eye and a red lens for the other eye. In the liquid crystal shutter glass type, a time-divisional screen is periodically repeated at a certain interval, and glasses having liquid crystal shutters synchronized with the interval are used.

The 3D image display apparatus having the liquid crystal shutter glass type alternately displays the first image for the left eye and the second image for the right eye, and opens and closes the liquid crystal shutters of the liquid crystal shutter glasses in accordance with the displayed image to display the 3D image.

However, a process for showing images to the observer may involve converting from the first image for the left eye to the second image for the right eye or converting from the second image for the right eye to the first image for the left eye. When the images are combined, which may require a time difference for both eyes and which may be divided according to the time difference, wrong images may be displayed in the left eye and the right eye. As a result, the observer may see overlapped images, thereby inducing eye fatigue and blurring of displayed images.

### SUMMARY OF THE INVENTION

Exemplary embodiments of the present invention provide a method of displaying an image capable of enhancing display quality.

Exemplary embodiments of the present invention also provide a method whereby an afterimage may be prevented and display quality may be enhanced.

Additional features of the invention will be set forth in the description which follows and, in part, will be apparent from the description or may be learned by practice of the invention.

An exemplary embodiment of the present invention discloses a method of displaying an image that comprises generating first unit pixel data and second unit pixel data from an input image and providing the first unit pixel data and the second unit pixel data to a first unit pixel and a second unit pixel, respectively, to display a first image and a second image, respectively. The first unit pixel comprises a first wavelength range corresponding to a primary color, and the second unit pixel comprises a second wavelength range corresponding to the primary color. The first wavelength range and the second wavelength range are different.

An exemplary embodiment of the present invention also discloses a display apparatus that comprises an image converting part to generate first unit pixel data and second unit pixel data from an input image and a display panel comprising a first unit pixel and a second unit pixel. The first unit pixel comprises a first wavelength range corresponding to a primary color, and the second unit pixel comprises a second wavelength range corresponding to the primary color with the first wavelength range and the second wavelength range being different. The display apparatus also includes a panel driving part to provide the first unit pixel data and the second unit pixel data to the first unit pixel and the second unit pixel to display a first image and a second image, respectively

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and, together with the description, serve to explain the principles of the invention.

FIG. 1 is a block diagram showing a display apparatus according to an exemplary embodiment of the present invention.

FIG. 2 is a block diagram showing an image converting part for the display apparatus shown in FIG. 1.

FIG. 3 is a plan view showing the display panel of FIG. 1.

FIG. 4 is a waveform diagram showing processing of an image using the display apparatus shown in FIG. 1.

FIG. 5 is a graph showing wavelength ranges of color pixels in the display panel shown in FIG. 1.

FIG. 6 is a perspective view showing wavelength division glasses and the display panel when a stereoscopic image is displayed on the display panel of FIG. 3.

FIG. 7 is a plan view showing a display panel according to another exemplary embodiment of the present invention.

FIG. 8 is a waveform diagram showing the processing of an image using the display apparatus of FIG. 7.

FIG. 9 is a plan view showing a display panel according to an additional exemplary embodiment of the present invention.

FIG. 10 is a waveform diagram showing processing of an image using the display apparatus of FIG. 9.

FIG. 11 is a block diagram showing an image converting part according to a further exemplary embodiment of the present invention.

### DETAILED DESCRIPTION OF THE ILLUSTRATED EMBODIMENTS

The present invention is described more fully hereinafter with reference to the accompanying drawings in which embodiments of the invention are shown. This invention may, however, be embodied in many different forms and should not be construed as limited to the embodiments set forth herein. Rather, these embodiments are provided so that this disclosure is thorough and will fully convey the scope of the invention to those skilled in the art. In the is drawings, the sizes and relative sizes of layers and regions may be exaggerated for clarity. Like reference numerals in the drawings denote like elements.

It will be understood that when an element or layer is referred to as being “on,” “connected to,” or “coupled to” another element or layer, it can be directly on, directly connected, or directly coupled to the other element or layer, or intervening elements or layers may be present. In contrast, when an element is referred to as being “directly on,” “directly connected to,” or “directly coupled to” another element or layer, there are no intervening elements or layers present. As used herein, the term “and/or” includes any and all combinations of one or more of the associated listed items.

It will be understood that, although the terms first, second, third, etc. may be used herein to describe various elements, components, regions, layers, and/or sections, these elements, components, regions, layers, and/or sections are not be limited by these terms. These terms are used to distinguish one element, component, region, layer, or section from another region, layer, or section. Thus, a first element, component, region, layer, or section discussed below could be termed a second element, component, region, layer, or section without departing from the teachings of this invention.

Spatially relative terms, such as “beneath,” “below,” “lower,” “above,” “upper,” and the like, may be used herein for ease of description to describe one element's or feature's relationship to another element(s) or feature(s) as shown in the figures. It will be understood that the spatially relative terms are intended to encompass different orientations of the device in use or operation in addition to the orientation shown in the figures. For example, if the device in the figures is turned over, elements described as “below” or “beneath” other elements or features would then be oriented “above” the other elements or features. Thus, the exemplary term is “below” can encompass both an orientation of above and below. The device may be otherwise oriented (rotated 90 degrees or at other orientations), and the spatially relative descriptors used herein may be interpreted accordingly.

The terminology used herein is for the purpose of describing particular exemplary embodiments only and is not intended to be limiting of the present invention. As used herein, the singular forms “a,” “an,” and “the” are intended to include the plural forms as well unless the context clearly indicates otherwise. It will be further understood that the terms “comprises” and/or “comprising,” when used in the specification, specify the presence of stated features, integers, steps, operations, elements, and/or components but do not preclude the presence or addition of one or more other features, integers, steps, operations, elements, components, and/or groups thereof.

Exemplary embodiments of the invention are described herein with reference to cross-sectional illustrations that are schematic illustrations of idealized exemplary embodiments (and intermediate structures) of the present invention. As such, variations from the shapes of the illustrations as a result, for example, of manufacturing techniques and/or tolerances, are to be expected. Thus, exemplary embodiments of the present invention should not be construed as limited to the particular shapes of regions illustrated herein but are to include deviations in shapes that result, for example, from manufacturing. For example, a region shown as a rectangle will, typically, have rounded or curved features. Thus, the regions shown in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to is which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present invention will be explained in detail with reference to the accompanying drawings.

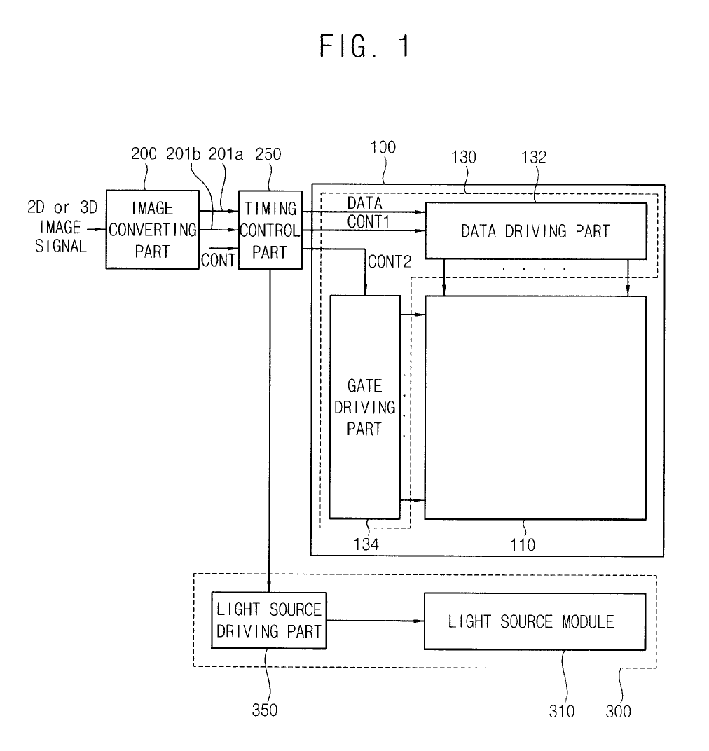

FIG. 1 is a block diagram showing a display apparatus according to an exemplary embodiment of the present invention.

Referring to FIG. 1, a display apparatus according to the present exemplary embodiment includes a display unit 100, an image converting part 200, and a timing control part 250. The display apparatus may selectively display a monoscopic image and a stereoscopic image. The display apparatus includes a display panel 110 to display, for example, an image that may have no less than a full high definition (FHD) resolution of 1,920×1,080.

The display unit 100 further includes a panel driving part 130 to drive the display panel 110. The panel driving part 130 includes a data driving part 132 and a gate driving part 134.

The display panel 110 may include two substrates and a liquid crystal layer that may be disposed between the two substrates. The display panel 110 may include a plurality of pixels to display an image. The pixels may be arranged in a matrix shape. Each of the pixels may include a transistor electrically connected to gate lines and data lines that cross each other and a liquid crystal capacitor and a storage capacitor electrically connected to the transistor. Additionally, each of the pixels may include a plurality of color pixels.

The plurality of pixels may be grouped into a first unit pixel UP1 and a second is unit pixel UP2. In this case, color pixels in the first unit pixel UP1 may have a wavelength range corresponding to a primary color that is different than a wavelength range of the second unit pixel UP2 that corresponds to a primary color.

The display panel 110 displays a first image in the first unit pixel UP 1 and a second image in the second unit pixel UP2 based on a data signal from the data driving part 132 and a gate signal from the gate driving part 134. The image converting part 200 receives an image signal from an external video system (not shown). The image signal may be a monoscopic image signal or a stereoscopic image signal. When the image converting part 200 receives the stereoscopic image as an input image, the image converting part 200 outputs a first output image 201 a including first unit pixel data corresponding to the first pixel UP1 for a left eye and second unit pixel data corresponding to the second pixel UP2 for a right eye. When the image converting part 200 receives the monoscopic image as an input image, the image converting part 200 outputs a second output image 201b including front first unit pixel data corresponding to the first pixel UP1 and front second unit pixel data corresponding to the second pixel UP2.

The timing control part 250 receives the first output image 201a, the second output image 201b, and a control signal CONT. The timing control part 250 provides the data driving part 132 with image data DATA, provides the data driving part 132 with a first control signal CONT1 to control a control timing of the data driving part 132, and provides the gate driving part 134 with a second control signal CONT2 to control a control timing of the gate driving part 134 based on the first output image 201a (or the second output image 201b) and the control signal CONT, respectively.

The data driving part 132 converts a digital data signal into an analog data voltage is based on the image data DATA and the first control signal CONT1 received from the timing control part 250 to output the analog data voltage to the data lines.

The gate driving part 134 generates the gate signals for driving the gate lines formed on the display panel 110 based on a second control signal CONT2 received from the timing control part 250 and sequentially outputs the gate signals to the gate lines.

The display apparatus may further include a light source device 300. The light source device 300 is disposed below the display panel 110 and provides the display panel 110 with light. The light source device 300 may include a light source module 310 and a light source driving part 350.

The light source module 310 may include at least one light-emitting block B (not shown). Each light-emitting block B may include a plurality of light sources. The light sources may be a point light source such as a light-emitting diode (LED). Alternatively, the light source may be a line light source such as a cold cathode fluorescent lamp (CCFL).

The light source driving part 350 generates a driving signal for driving the light-emitting block B in accordance with a controlling signal from the timing control part 250. The light source driving part 350 drives the light-emitting block B using the driving signal.

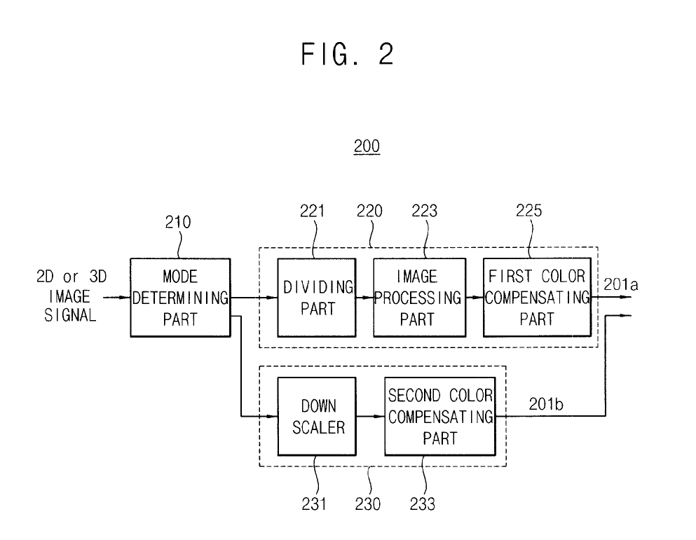

FIG. 2 is a block diagram showing an image converting part for use with the display unit shown in FIG. 1.

Referring to FIG. 1 and FIG. 2, the image converting part 200 includes a mode determining part 210, a three-dimensional (3D) image processing part 220 and a two-dimensional (2D) image processing part 230.

The mode determining part 210 determines a mode of an input image, i.e., whether the input image is stereoscopic or monoscopic. The mode determining part 210 receives is the monoscopic image signal or the stereoscopic image signal. The mode determining part 210 provides the 3D image processing part 220 with the stereoscopic image signal when the input image is the stereoscopic image signal, and provides the 2D image processing part 230 with the monoscopic image signal when the input image is the monoscopic image signal.

The 3D image processing part 220 includes a dividing part 221, an image processing part 223, and a first color compensating part 225.

The stereoscopic image signal includes a first image for a left eye and a second image for a right eye. Thus, the dividing part 221 divides the stereoscopic image signal from the mode determining part 210 into the first image and the second image.

The image processing part 223 processes the divided first image to correspond to the first unit pixel and the divided second image to correspond to the second unit pixel so that first image processing data and second image processing data are respectively generated.

The first color compensating part 225 includes a reference color lookup table. The first color compensating part 225 compensates the first and second image processing data using the reference color lookup table and a color deviation between the first and second unit pixels UP1 and UP2. Thus, the first color compensating part 225 may output the first output image 201a including the first unit pixel data for the left eye and the second unit pixel data for the right eye.

For example, a color in the first unit pixel UP1 and a color in the second unit pixel UP2 may be perceived to an observer's eyes differently because the color pixels in the first unit pixel UP1 and the color pixels in the second unit pixel UP2 have different wavelengths although each corresponds to a primary color. Thus, the first color compensating part 225 may prevent a specific color from being strongly perceived to the observer's eyes.

Therefore, the first image corresponding to the compensated first unit pixel data and the second image corresponding to the compensated second unit pixel data may be respectively displayed on the first unit pixel UP1 and the second unit pixel UP2 when the image signal is the stereoscopic image signal.

The 2D image processing part 230 includes a down scaler 231 and a second color compensating part 233.

The monoscopic image signal received from the mode determining part 210 has a first resolution. The down scaler 231 scales down the first resolution to a second resolution. In this case, the first resolution may be higher than the second resolution. For example, the first resolution may be twice the second resolution.

The second color compensating part 233 compensates the monoscopic image signal having the second resolution outputted from the down scaler 231 using the color deviation between the first and second unit pixels UP1 and UP2 to output the second output signal 201b including the first unit pixel data corresponding to the first unit pixel UP1 and the second unit pixel data corresponding to the second unit pixel UP2.

At this time, a resolution of an image displayed on the display panel 110 may be half the resolution of the input image; however, all colors in the first and second unit pixels UP1 and UP2, which have wavelength ranges different from each other with respect to the same color, may be used. Thus, a color range may be enlarged.

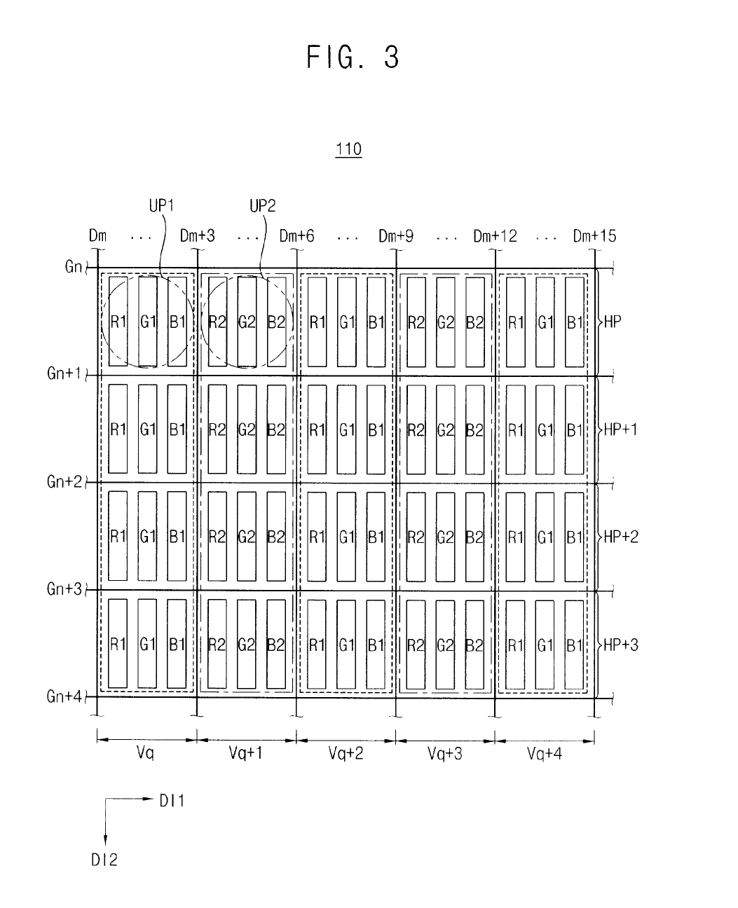

FIG. 3 is a plan view of the display panel of FIG. 1.

Referring to FIG. 1 and FIG. 3, the display panel 110 includes a plurality of gate lines Gn, . . . , Gn+4, a plurality of data lines Dm, . . . , Dm+15, and a plurality of pixels defined by the gate lines Gn, . . . , Gn+4 and the data lines Dm, . . . , Dm+15. The pixels include a plurality of is pixel rows Hp, . . . , Hp+3, and a plurality of pixel columns Vq, . . . , Vq+4. The pixel columns Vq, . . . , Vq+4 are arranged in a first direction DI1, and each of the pixel columns Vq, . . . , Vq+4 extends in a second direction DI2 substantially perpendicular to the first direction DI1. In addition, the pixel rows Hp, . . . , Hp+3 are arranged in the second direction DI2, and each of the pixel rows Hp, . . . , Hp+3 extends in the first direction DI1. For example, a p-th pixel row Hp includes pixels electrically connected to a (n+1)-th gate line Gn+1, and a (p+1)-th pixel row Hp+1 includes pixels electrically connected to a (n+2)-th gate line Gn+2. In this case, m, n, p and q are natural numbers.

The plurality of pixels may be grouped into a first unit pixel UP1 and a second unit pixel UP2. Each first unit pixel UP1 includes a first red pixel R1, a first green pixel G1, and a first blue pixel B1. Each second unit pixel UP2 includes a second red pixel R2, a second green pixel G2, and a second blue pixel B2.

The first red pixel R1 and the second red pixel R2 have wavelength ranges different from each other. The first green pixel G1 and the second green pixel G2 have wavelength ranges different from each other. The first blue pixel B1 and the second blue pixel B2 have wavelength ranges different from each other.

A plurality of first unit pixels UP1 is arranged in a first pixel column Vq, in a third pixel column Vq+2, and in a fifth pixel column Vq+4. A plurality of second unit pixels UP2 is arranged in a second pixel column Vq+1 and in a fourth pixel column Vq+3. Accordingly, a pixel column including the first unit pixel UP1 and a pixel column including the second unit pixel UP2 are alternately disposed with each other.

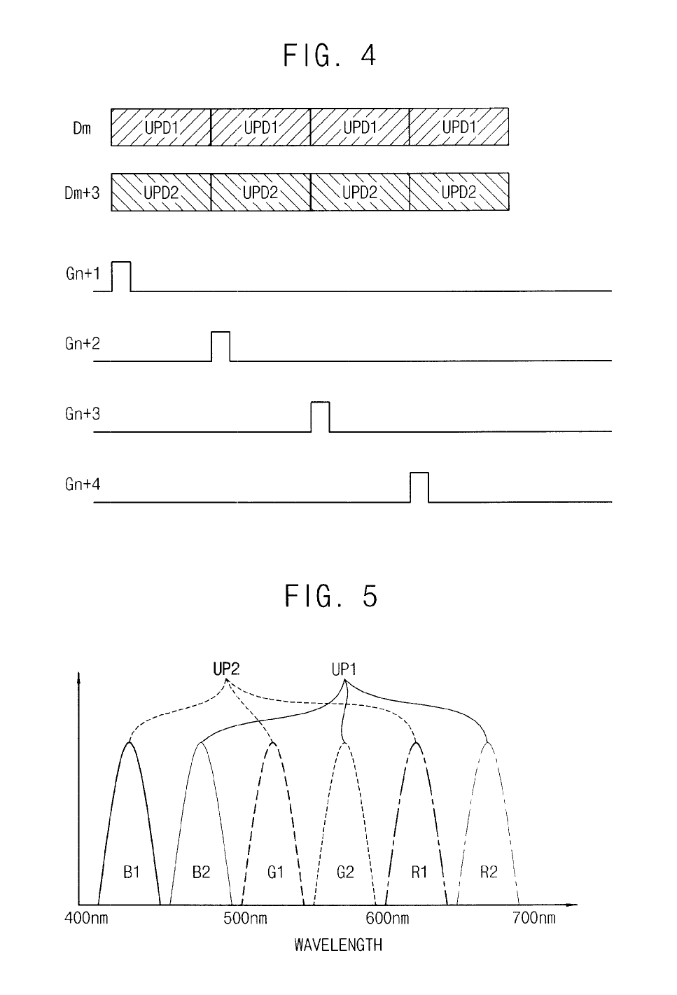

FIG. 4 is a waveform diagram showing processing of an image using the display apparatus of FIG. 1.

Referring to FIG. 1, FIG. 2, FIG. 3, and FIG. 4, the timing control part 250 receives the first output image 201a, the second output image 201b, and the control signal CONT. The timing control part 250 provides the data driving part 132 with the image data DATA. The timing control part 250 generates the first control signal CONT1 to control the driving timing of the data driving part 132 and the second control signal CONT2 to control the driving timing of the gate driving part 134 and respectively provides the first and second control signals CONT1 and CONT2 to the data and gate driving parts 132 and 134.

The data driving part 132 provides a first unit pixel data UPD1 to a first data line Dm and a second unit pixel data UPD2 to a second data line Dm+3 based on the image data DATA and the first control signal CONT1.

The gate driving part 134 sequentially provides the gate signals to the gate lines Gn, . . . , Gn+4 in the display panel 110 based on the second control signal CONT2.

For example, when a first gate line Gn+1 receives a gate signal of a high level, the first unit pixel data UPD1 are applied to a pixel defined by a first pixel row Hp and the first pixel column Vq, and the second unit pixel data UPD2 are applied to a pixel defined by the first pixel row Hp and the second pixel column Vq+1 so that the first image and the second image are displayed on the display panel 110.

When a second gate line Gn+2 receives a gate signal of a high level, the first unit pixel data UPD1 are applied to a pixel defined by a second pixel row Hp+1 and the first pixel column Vq, and the second unit pixel data UPD2 are applied to a pixel defined by the second pixel row Hp+1 and the second pixel column Vq+1 so that the first image and the second image are displayed on the display panel 110.

When a third gate line Gn+3 receives a gate signal of a high level, the first unit is pixel data UPD1 are applied to a pixel defined by a third pixel row Hp+2 and the first pixel column Vq, and the second unit pixel data UPD2 are applied to a pixel defined by the third pixel row Hp+2 and the second pixel column Vq+1 so that the first image and the second image are displayed on the display panel 110.

When a fourth gate line Gn+4 receives a gate signal of a high level, the first unit pixel data UPD1 are applied to a pixel defined by a fourth pixel row Hp+3 and the first pixel column Vq, and the second unit pixel data UPD2 are applied to a pixel defined by the fourth pixel row Hp+3 and the second pixel column Vq+1 so that the first image and the second image are displayed on the display panel 110.

When the stereoscopic image signal is applied to the image converting part 200 as the input image, the first unit pixel data UPD1 based on the first image for the left eye are applied to the first pixel column Vq, and the second unit pixel data UPD2 based on the second image for the right eye are applied to the second pixel column Vq+1.

When the monoscopic image signal having the first resolution is applied to the image converting part 200 as the input image, the first unit pixel data UPD1 and the second unit pixel data UPD2 based on the monoscopic image signal corresponding to one pixel are respectively applied to one of the pixels in the first pixel column Vq and one of the pixels in the second pixel column Vq+1. For example, the first unit pixel UP1 and the second unit pixel UP2 alternately disposed in the same pixel row may respectively receive the first unit pixel data UPD1 and the second unit pixel data UPD2 based on the monoscopic image signal corresponding to one pixel.

In this case, all colors in the first and second unit pixels UP1 and UP2, which have different wavelength ranges from each other with respect to the same color, may be used. Thus, is a color range may be enlarged.

FIG. 5 is a graph showing wavelength ranges of color pixels for the display panel of FIG. 1.

Referring to FIG. 1, FIG. 3, and FIG. 5, the first red pixel R1 and the second red pixel R2 may have similar wavelength ranges without overlapping with each other. For example, the first red pixel R1 may have a wavelength in a range from about 600 nm to about 650 nm, and the second red pixel R2 may have a wavelength in a range from about 650 nm to about 700 nm. In this case, the wavelength ranges of the first red pixel R1 and the second red pixel R2 may be switched.

The first green pixel G1 and the second green pixel G2 may have similar wavelength ranges without overlapping with each other. For example, the first green pixel G1 may have a wavelength in a range from about 500 nm to about 550 nm, and the second green pixel G2 may have a wavelength in a range from about 550 nm to about 600 nm. In this case, the wavelength ranges of the first green pixel G1 and the second green pixel G2 may be switched.

The first blue pixel B1 and the second blue pixel B2 may have similar wavelength ranges without overlapping with each other. For example, the first blue pixel B1 may have a wavelength in a range from about 400 nm to about 450 nm, and the second blue pixel B2 may have a wavelength in a range from about 450 nm to about 500 nm. In this case, the wavelength ranges of the first blue pixel B1 and the second blue pixel B2 may be switched.

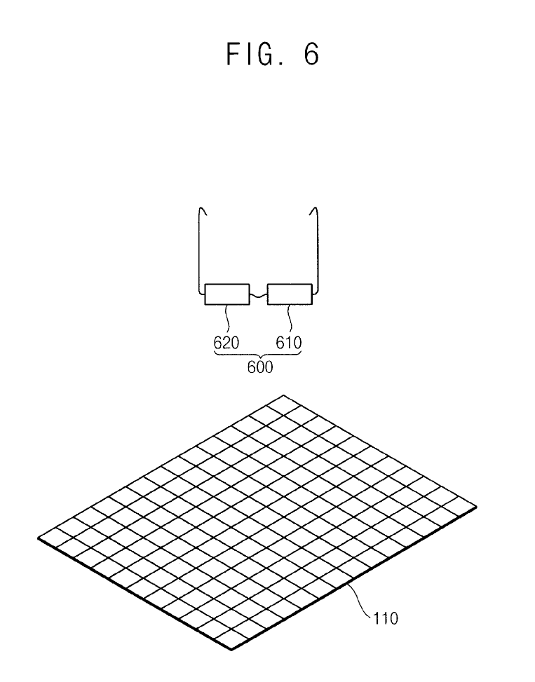

FIG. 6 is a perspective view showing wavelength division glasses and the display panel when a stereoscopic image is displayed on the display panel of FIG. 3.

Referring to FIG. 1, FIG. 3, and FIG. 6, the wavelength division glasses 600 is include a first lens 610 and a second lens 620. In this case, the first lens 610 represents a left lens, and the second lens 620 represents a right lens.

Each of the first lens 610 and the second lens 620 blocks light having wavelengths in particular ranges.

For example, the first lens 610 transmits a first light having a first wavelength range of the color pixels in the first unit pixel UP1 and blocks a second light having a second wavelength range of the color pixels in the second unit pixel UP2.

In addition, the second lens 620 transmits the second light and blocks the first light.

Thus, the first image for the left eye, which is displayed on the first unit pixel UP1, is perceived by an observer's left eye, and the second image for the right eye, displayed on the second unit pixel UP2, is perceived by an observer's right eye. Therefore, an observer may perceive a 3D effect.

According to the present exemplary embodiment, the display apparatus may selectively display the stereoscopic image and the monoscopic image. In addition, when the display apparatus displays the stereoscopic image, the glasses 600 and the display apparatus may not need to be synchronized with each other. Thus, an afterimage generated during a conversion of the left image into the right image or the right image into the left image due to a slow response time of the liquid crystal may be prevented. In addition, the first image for the left eye and the second image for the right eye may be selectively and respectively provided to the left eye and the right eye of the observer through the wavelength division glasses although the first and second images are displayed at the same time, and, thus, a converting process from the first image to the second image or from the second image to the first image may not be perceived by is the observer's eyes.

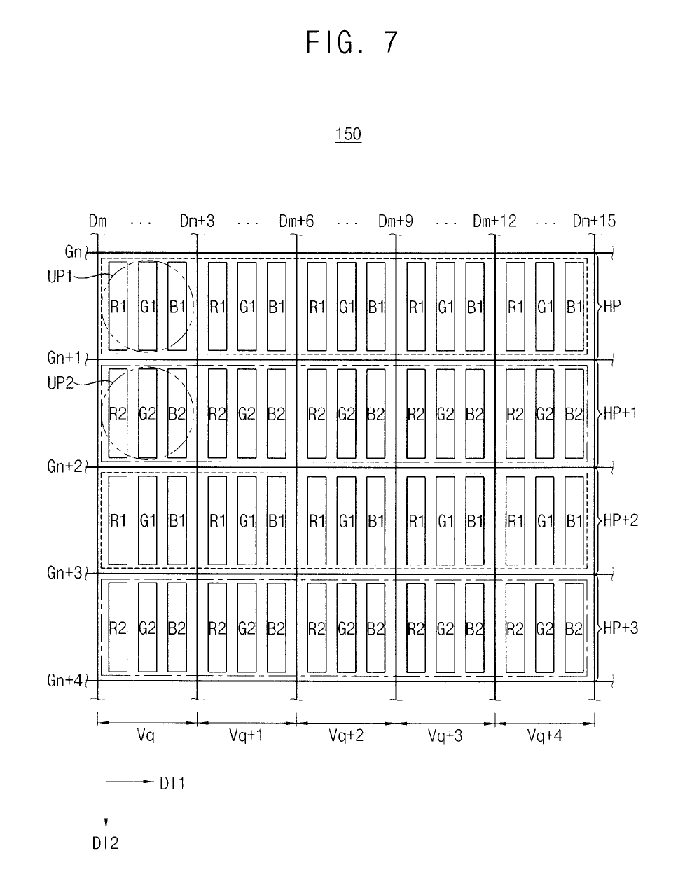

FIG. 7 is plan view showing a display panel according to another exemplary embodiment of the present invention.

A display apparatus and an image converting part according to the present exemplary embodiment are substantially the same as the display apparatus and the image converting part according to the previous exemplary embodiment shown in FIG. 1, FIG. 2, FIG. 3, FIG. 4, FIG. 5, and FIG. 6 except that the display apparatus including a display panel 150 has a different pixel arrangement as compared with the display panel 110. Thus, a block diagram of the display apparatus and a block diagram of the image converting part according to the present exemplary embodiment will be omitted.

Hereinafter, the same reference numerals will be used to refer to the same or like parts as those described in the previous exemplary embodiment, and repetitive explanation of the above described elements will be omitted.

Referring to FIG. 1 and FIG. 7, the plurality of pixels may be grouped into a first unit pixel UP1 and a second unit pixel UP2.

A plurality of first unit pixels UP1 is arranged in a first pixel row Hp and in a third pixel row Hp+2. A plurality of second unit pixels UP2 is arranged in a second pixel row Hp+1 and in a fourth pixel row Hp+3. Accordingly, a pixel row including the first unit pixel UP1 and a pixel row including the second unit pixel UP2 are alternately disposed with each other.

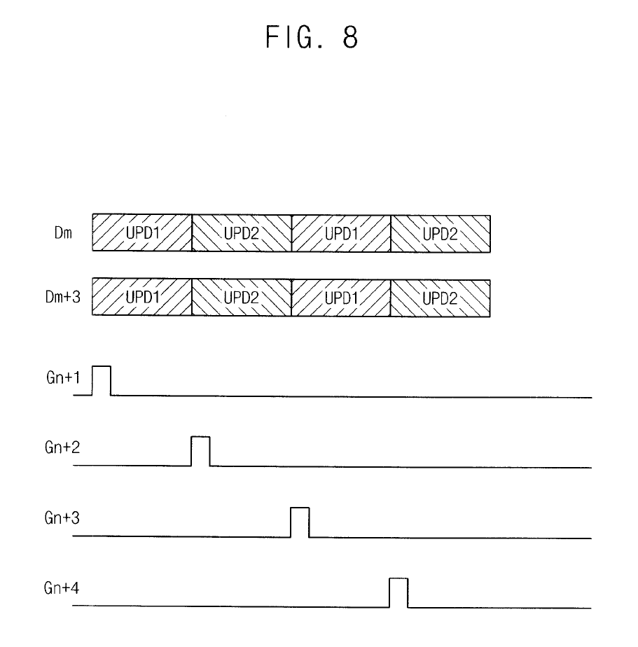

FIG. 8 is a waveform diagram showing processing of an image by a display apparatus including the display panel of FIG. 7.

Referring to FIG. 1, FIG. 2, FIG. 7, and FIG. 8, the data driving part 132 is alternately provides first unit pixel data UPD1 and second unit pixel data UPD2 to a first data line Dm and alternately provides the first unit pixel data UPD1 and the second unit pixel data UPD2 to a second data line Dm+3 based on the image data DATA and the first control signal CONT1.

For example, when a first gate line Gn+1 receives a gate signal of a high level, the first unit pixel data UPD1 are applied to a pixel defined by the first pixel row Hp and a first pixel column Vq and a pixel defined by the first pixel row Hp and a second pixel column Vq+1 so that the first image is displayed on the display panel 150.

When a second gate line Gn+2 receives a gate signal of a high level, the second unit pixel data UPD2 are applied to a pixel defined by the second pixel row Hp+1 and the first pixel column Vq and a pixel defined by the second pixel row Hp+1 and the second pixel column Vq+1 so that the second image is displayed on the display panel 150.

When a third gate line Gn+3 receives a gate signal of a high level, the first unit pixel data UPD1 are applied to a pixel defined by the third pixel row Hp+2 and the first pixel column Vq and a pixel defined by the third pixel row Hp+2 and the second pixel column Vq+1 so that the first image is displayed on the display panel 150.

When a fourth gate line Gn+4 receives a gate signal of a high level, the second unit pixel data UPD2 are applied to a pixel defined by the fourth pixel row Hp+3 and the first pixel column Vq and a pixel defined by the fourth pixel row Hp+3 and the second pixel column Vq+1 so that the second image is displayed on the display panel 150.

When the stereoscopic image signal is applied to the image converting part 200, the first unit pixel data UPD1 based on the first image for the left eye are applied to the first pixel row Hp, and the second unit pixel data UPD2 based on the second image for the right eye are is applied to the second pixel row Hp+1.

When the monoscopic image signal having the first resolution is applied to the image converting part 200, the first unit pixel data UPD1 and the second unit pixel data UPD2 based on the monoscopic image signal corresponding to one pixel are respectively applied to one of the pixels in the first pixel row Hp and one of the pixels in the second pixel row Hp+1. For example, the first unit pixel UP1 and the second unit pixel UP2 alternately disposed in the same pixel column may respectively receive the first unit pixel data UPD1 and the second unit pixel data UPD2 based on the monoscopic image signal corresponding to one pixel.

Wavelength ranges of color pixels in the display panel 150 in FIG. 7 are substantially the same as the wavelength ranges in FIG. 5, and, thus, repetitive explanations will be omitted.

When the display apparatus including the display panel 150 in FIG. 7 and wavelength division glasses are used to display the stereoscopic image, they are substantially the same as the wavelength division glasses 600 in FIG. 6, and, thus, repetitive explanations will be omitted.

The display panel 150 according to the present exemplary embodiment may have its pixel arrangement different from that of the display panel 110 according to the previous exemplary embodiment shown in FIG. 1, FIG. 2, FIG. 3, FIG. 4, FIG. 5, and FIG. 6.

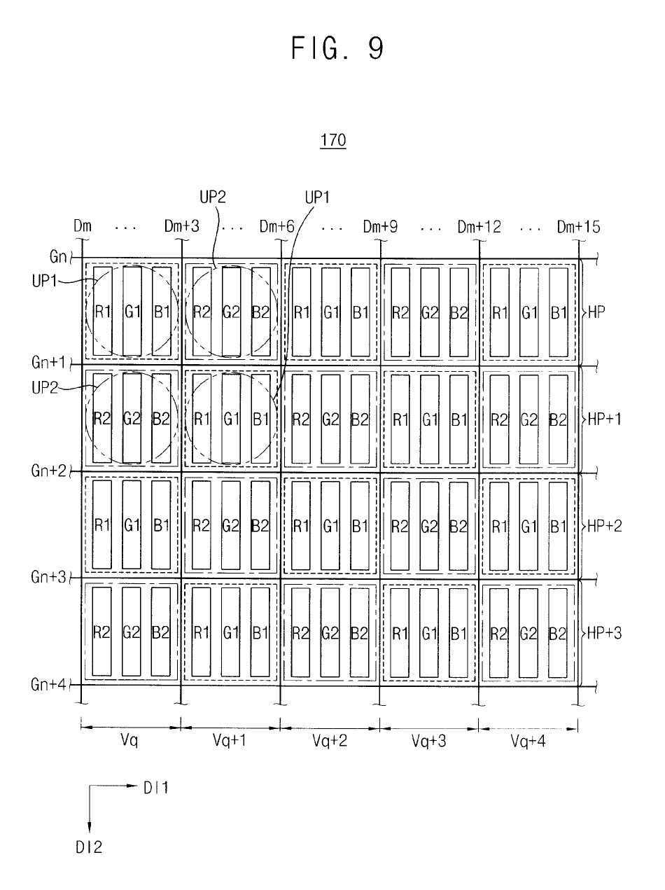

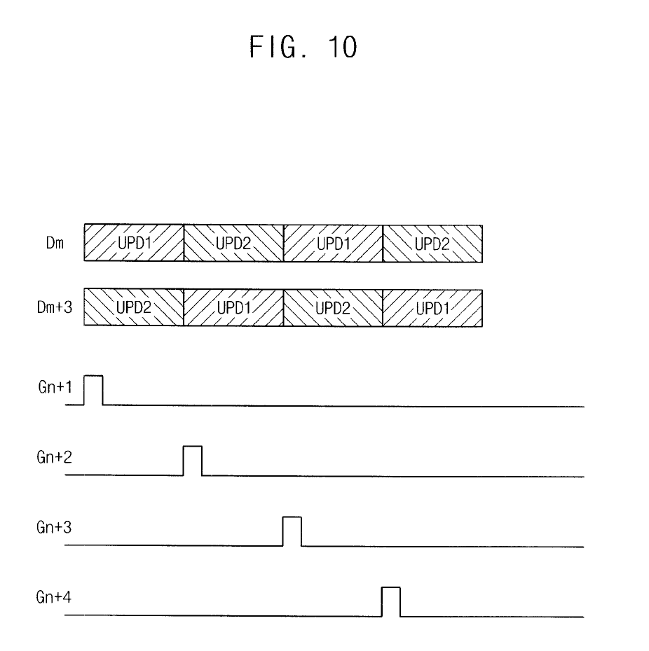

FIG. 9 is a plan view showing a display panel according to still another exemplary embodiment of the present invention.

A display apparatus and an image converting part according to the present exemplary embodiment are substantially the same as the display apparatus and the image converting part according to the previous exemplary embodiment in FIG. 7 and FIG. 8 except is that the display apparatus includes a display panel 170 having a pixel arrangement that is different from that of the display panel 150. Thus, a block diagram of the display apparatus and a block diagram of the image converting part according to the present exemplary embodiment will be omitted.

Hereinafter, the same reference numerals will be used to refer to the same or like parts as those described in the previous exemplary embodiment shown in FIG. 1 FIG. 2, FIG. 3, FIG. 4, FIG. 5, and FIG. 6, and repetitive explanation concerning the above described elements will be omitted.

Referring to FIG. 1 and FIG. 9, the plurality of pixels may be grouped into a first unit pixel UP1 and a second unit pixel UP2.

The first unit pixel UP1 and the second unit pixel UP2 are disposed in a checkerboard pattern.

FIG. 10 is a waveform diagram showing processing of an image using a display apparatus including the display panel of FIG. 9.

Referring to FIG. 1, FIG. 2, FIG. 9, and FIG. 10, the data driving part 132 alternately provides first unit pixel data UPD1 and second unit pixel data UPD2 to a first data line Dm and the second unit pixel data UPD2 and the first unit pixel data UPD1 to a second data line Dm+3 based on the image data DATA and the first control signal CONT1.

For example, when a first gate line Gn+1 receives a gate signal of a high level, the first unit pixel data UPD1 are applied to a pixel defined by a first pixel row Hp and a first pixel column Vq, and the second unit pixel data UPD2 are applied to a pixel defined by the first pixel row Hp and the second pixel column Vq+1 so that the first image and the second image are displayed on the display panel 170.

When a second gate line Gn+2 receives a gate signal of a high level, the second unit pixel data UPD2 are applied to a pixel defined by a second pixel row Hp+1 and the first pixel column Vq, and the first unit pixel data UPD1 are applied to a pixel defined by the second pixel row Hp+1 and the second pixel column Vq+1 so that the second image and the first image are displayed on the display panel 170.

When a third gate line Gn+3 receives a gate signal of a high level, the first unit pixel data UPD1 are applied to a pixel defined by a third pixel row Hp+2 and the first pixel column Vq, and the second unit pixel data UPD2 are applied to a pixel defined by the third pixel row Hp+2 and the second pixel column Vq+1 so that the first image and the second image are displayed on the display panel 170.

When a fourth gate line Gn+4 receives a gate signal of a high level, the second unit pixel data UPD2 are applied to a pixel defined by a fourth pixel row Hp+3 and the first pixel column Vq, and the first unit pixel data UPD1 are applied to a pixel defined by the fourth pixel row Hp+3 and the second pixel column Vq+1 so that the second image and the first image are displayed on the display panel 170.

When the stereoscopic image signal is applied to the image converting part 200 as an input image, the first unit pixel data UPD1 based on the first image for the left eye and the second unit pixel data UPD2 based on the second image for the right eye are alternately applied to pixels in each pixel row and in each pixel column.

When the monoscopic image signal having the first resolution is applied to the image converting part 200 as the input image, the first unit pixel data UPD1 and the second unit pixel data UPD2 based on the monoscopic image signal corresponding to one pixel are alternately applied to the pixels in each pixel row and in each pixel column.

Wavelength ranges of color pixels in the display panel 170 in FIG. 9 are substantially the same as those in FIG. 5, and, thus, repetitive explanations will be omitted.

Wavelength division glasses used when the display apparatus including the display panel in FIG. 9 displays the stereoscopic image are substantially the same as the wavelength division glasses 600 in FIG. 6, and, thus, repetitive explanations will be omitted.

According to the present exemplary embodiment, the first unit pixel UP1 and the second unit pixel UP2 of the display panel 170 are alternately disposed in each of the pixel columns Vq, . . . , Vq+4 and in each of the pixel rows Hp, . . . , Hp+3, and, thus, the phenomenon that a specific color may be strongly perceived as a line to the observer's eyes may be decreased. Therefore, display quality may be enhanced more than the previous exemplary embodiments.

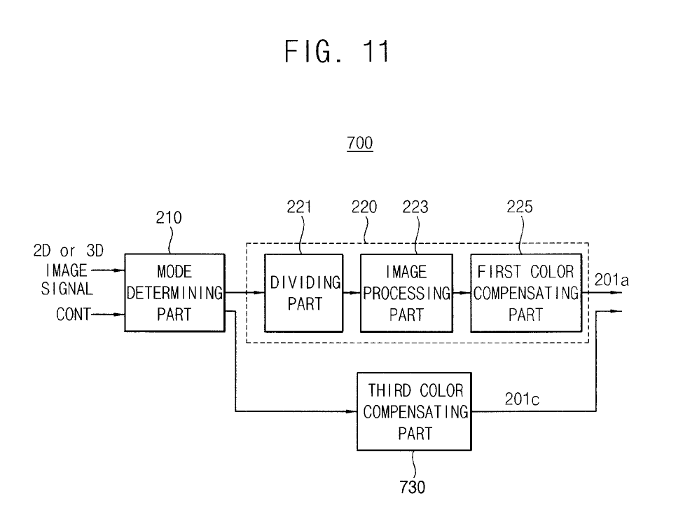

FIG. 11 is a block diagram showing an image converting part according to still another exemplary embodiment of the present invention.

A display apparatus according to the present exemplary embodiment is substantially the same as the display apparatus according to the previous exemplary embodiment shown in FIG. 9 and FIG. 10 except that the display apparatus of the present exemplary embodiment includes an image converting part 700 instead of the image converting part 200. Thus, a block diagram of the display apparatus according to the present exemplary embodiment will be omitted.

In addition, the image converting part 700 is substantially the same as the image converting part 200 according to the previous exemplary embodiment shown in FIG. 9 and FIG. 10 except that the image converting part 700 includes a third color compensating part 730 instead of the 2D image processing part 230. Thus, the same reference numerals will be used to refer to the same or like parts as those described in the previous exemplary embodiment, and is repetitive explanation of the above described elements will be omitted.

Referring to FIGS. 1 and FIG. 11, the third compensating part 730 (hereinafter referred to as “2D image processing part”) receives a monoscopic image signal having a first resolution from the mode determining part 210.

The 2D image processing part 730 compensates the monoscopic image signal having the first resolution based on the color deviation between the first and second unit pixels UP1 and UP2 and generates a third output signal 201 c including the first and second unit pixel data UPD1 and UPD2 respectively corresponding to the first and second unit pixels UP1 and UP2.

The display apparatus according to the present exemplary embodiment may include the display panels 110, 150, and 170 according to the previous exemplary embodiments.

The stereoscopic image signal processing according to the present exemplary embodiment is substantially the same as the stereoscopic image signal processing according to the previous exemplary embodiments except that the third output signal 201c is applied to the timing control part 250. Thus, repetitive explanations concerning the above described elements will be omitted.

According to the present exemplary embodiment, the monoscopic image signal having the first resolution passes through only the 2D image processing part 730 and is processed to the third output signal 201c including the first and second unit pixel data UPD1 and UPD2, and, thus, the resolution may not be changed.

As described above, when the stereoscopic image is displayed, the first image for the left eye and the second image for the right eye may be selectively provided to the left eye and the right eye of the observer through the wavelength division glasses although the first and is second images are displayed at the same time. Thus, a converting process from the first image to the second image or from the second image to the first image may be not shown to the observer as an afterimage, thereby enhancing the display quality.

The foregoing is illustrative of the present invention and is not to be construed as limiting thereof.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. A method of displaying an image, comprising:
generating first unit pixel data and second unit pixel data using an input image; and
providing the first unit pixel data and the second unit pixel data to a first unit pixel and a second unit pixel, respectively, to display a first image and a second image, respectively,
wherein the first image comprises a first wavelength range corresponding to a primary color, the second image comprises a second wavelength range corresponding to the primary color, and the first wavelength range and the second wavelength range do not overlap with each other.

2. The method of claim 1, further comprising:
transmitting a first light comprising the first wavelength range of the first unit pixel through a first lens and a second light comprising the second wavelength range of the second unit pixel through a second lens.

3. The method of claim 1, wherein generating the first unit pixel data and the second unit pixel data comprises:
dividing the input image into a first image for a left eye and a second image for a right eye when the input image comprises a stereoscopic image;
generating first image processing data corresponding to the first unit pixel using the first image and second image processing data corresponding to the second unit pixel using the second image; and
converting the first image processing data and the second image processing data into the first unit pixel data and the second unit pixel data using a color deviation between the first unit pixel and the second unit pixel.

4. The method of claim 1, wherein generating the first unit pixel data corresponding to the first unit pixel and the second unit pixel data corresponding to the second unit pixel comprises:
using a monoscopic image and a color deviation between the first unit pixel and the second unit pixel when the input image is the monoscopic image.

5. The method of claim 1, wherein generating the first unit pixel data and the second unit pixel data comprises:
scaling a first resolution of the input image to a second resolution when the input image is a monoscopic image, the first resolution being higher than the second resolution; and
generating the first unit pixel data corresponding to the first unit pixel and the second unit pixel data corresponding to the second unit pixel using a color deviation between the first unit pixel and the second unit pixel and the monoscopic image comprising the second resolution.

6. A display apparatus comprising:
an image converting part to generate first unit pixel data and second unit pixel data using an input image;
a display panel comprising a first unit pixel and a second unit pixel, the first unit pixel to display a first image comprising a first wavelength range corresponding to a primary color, the second unit pixel to display a second image comprising a second wavelength range corresponding to the primary color, and the first wavelength range and the second wavelength range do not overlap with each other; and
a panel driving part to provide the first unit pixel data and the second unit pixel data to the first unit pixel and the second unit pixel to display the first image and the second image, respectively.

7. The display apparatus of claim 6, further comprising:
glasses, comprising:
a first lens to transmit a first light and to block a second light; and
a second lens to transmit a second light and to block the first light,
wherein the first light comprises the first wavelength range of the first image, and the second light comprises the second wavelength range of the second image.

8. The display apparatus of claim 6, wherein the image converting part comprises:
a mode determining part to determine a mode of the input image;
a three-dimensional (3D) image processing part to generate the first unit pixel data corresponding to the first unit pixel and the second unit pixel data corresponding to the second s unit pixel when the input image comprises a stereoscopic image; and
a two-dimensional (2D) image processing part to generate the first unit pixel data corresponding to the first unit pixel and the second unit pixel data corresponding to the second unit pixel when the input image comprises a monoscopic image,
wherein the first unit pixel data corresponds to the first image for a left eye, and the second unit pixel data corresponds to the second image for a right eye.

9. The display apparatus of claim 8, wherein the 3D image processing part comprises:
a dividing part to divide the input image into the first image for the left eye and the second image for the right eye;
an image processing part to generate first image processing data corresponding to the first unit pixel using the first image and second image processing data corresponding to the second unit pixel using the second image; and
a first color compensating part to convert the first image processing data and the second image processing data into the first unit pixel data and the second unit pixel data using a color deviation between the first unit pixel and the second unit pixel.

10. The display apparatus of claim 9, wherein the 2D image processing part comprises:
a scaler to scale a first resolution of the input image to a second resolution when the input image is the monoscopic image, the first resolution being higher than the second resolution; and
a second color compensating part to generate the first unit pixel data corresponding to the first unit pixel and the second unit pixel data corresponding to the second unit pixel using a color deviation between the first unit pixel and the second unit pixel and the monoscopic image comprising the second resolution.

11. The display apparatus of claim 9, wherein the 2D image processing part comprises:
a third color compensating part to generate the first unit pixel data corresponding to the first unit pixel and the second unit pixel data corresponding to the second unit pixel using the input image and a color deviation between the first unit pixel and the second unit pixel when the input image is the monoscopic image.

12. The display apparatus of claim 6, wherein the first unit pixel comprises a first red pixel, a first green pixel, and a first blue pixel, and the second unit pixel comprises a second red pixel, a second green pixel, and a second blue pixel.

13. The display apparatus of claim 12, wherein the first red pixel and the second red pixel comprise wavelength ranges from 600 nm to 700 nm, the first green pixel and the second green pixel comprise wavelength ranges from 500 nm to 600 nm, and the first blue pixel and the second blue pixel comprise wavelength ranges from 400 nm to 500 nm.

14. The display apparatus of claim 6, wherein the display panel further comprises a plurality of first unit pixels and a plurality of second unit pixels, the first unit pixels and the second unit pixels being arranged in a matrix shape,
wherein the first unit pixels are arranged in a first pixel column, the second unit pixels s are arranged in a second pixel column, and the first pixel column and the second pixel column are alternately disposed with each other.

15. The display apparatus of claim 6, wherein the display panel further comprises a plurality of first unit pixels and a plurality of second unit pixels, the first unit pixels and the second unit pixels being arranged in a matrix shape,
wherein the first unit pixels are arranged in a first pixel row, the second unit pixels are arranged in a second pixel row, and the first pixel row and the second pixel row are alternately disposed with each other.

16. The display apparatus of claim 6, wherein the display panel further comprises a plurality of first unit pixels and a plurality of second unit pixels, the first unit pixels and the second unit pixels being arranged in a matrix shape,
wherein the first unit pixels and the second unit pixels are arranged in a checkerboard pattern.
